(19) United States
(12) Patent Application Publication
(10) Pub. No.: US 2010/0178432 A1
(43) Pub. Date: Jul. 15, 2010

(54) Method of Forming Pattern Film, and Pattern Film Forming Apparatus

(76) Inventors: Yoshikazu Kondo, Tokyo (JP); Akira Nishiwaki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/223,194

(22) PCT Filed: Jan. 18, 2007
(86) PCT No.: PCT/JP2007/050676

§ 371 Date: Jul. 24, 2008

(30) Foreign Application Priority Data
Feb. 8, 2006 (JP) 2006-030833

(51) Int. Cl. B05D 5/12; B05C 5/00

(52) U.S. Cl. 427/535; 118/620

(57) ABSTRACT

An objective is to provide a method of forming a pattern film in which a dense conductive pattern with no defect can be formed even in a low temperature treatment, the formed pattern film having the same thickness as in the conventional method exhibits excellent properties of conductivity, film strength, transmittance and so forth together with improved stability at high temperature and humidity, and a pattern film with no lack can be stably formed with an easy-to-use apparatus, and to provide a pattern film forming apparatus thereof. Disclosed is a method of forming a pattern film possessing the steps of forming a thin film in a form of a predetermined geometric pattern on a substrate employing a solution comprising a metal ion, and subsequently treating the thin film via an atmospheric pressure plasma treatment to prepare a pattern film.

### TECHNICAL FIELD

The present invention relates to a novel method of forming a pattern film and a pattern film forming apparatus, and specifically to a method of forming a pattern film by which a pattern film exhibiting excellent film properties and excellent stability at high temperature can be formed with an easy-to-use apparatus, and a pattern film forming apparatus thereof.

### BACKGROUND

Generally, as a method of manufacturing a device fitted with a wiring circuit such as an electronic circuit or an integrated circuit, for example, a photolithography technique is utilized. This photolithography technique is one by which a photosensitive material called resist is coated on a substrate on which a conductive film has been coated in advance, a circuit pattern is exposed to light to conduct a developing treatment, and the conductive film is etched based on the resist pattern to form a geometrically shaped wiring pattern of a thin film. In the case of this photolithography technique, large scale facilities such as an evaporator and so forth, and complicated processes are desired to be arranged, and manufacturing cost is high since efficiency in the use of material is roughly a few % and most of the material has to be discarded.

Further, as another method of forming a geometrically shaped circuit pattern, a subtractive process by which only the conductive circuit pattern is left over and undesired portions are removed by etching copper foils of the copper clad laminate, and an additive process by which a circuit pattern is plated on the substrate surface have often been utilized in the past. However, in these circuit-forming methods, adhesion of a substrate to the formed circuit pattern is insufficient, and the employed substrate is damaged, whereby a continuous treatment process is difficult to be conducted, resulting in generation of the barrier to automation. Further, there is another problem such that a number of manufacturing processes need to be provided together with a large amount of equipment cost and time in addition to generation of a large amount of a treatment waste solution.

In order to solve these problems, utilized is a method of forming a circuit with a conductive paste containing metal particles made of gold or the like. The conductive paste contains the metal particle covered by an organic compound. Commonly known is a method of forming a circuit by providing conductivity via bonding of metal particle-to-metal particle, after patterning a circuit pattern by printing the conductive paste on the insulating substrate surface with each of various methods, and subsequently baking the organic compound, by which the metal particle is covered, via a heat treatment of the foregoing.

On the other hand, a conductive paste containing a material in which the surface of nanosized metal particles each having an average particle diameter of 1-100 nm is covered by an organic compound is developed and disclosed is circuit formation employing this conductive paste (refer to Patent Document 1). Usable examples of metal particles each having an average particle diameter of 1-100 nm include particles made of Au, Pt, Cu, Ni, Cr, Co, Zn, In, Sn and so forth, and the nanosized metal particles are dispersed in binder or a solvent to prepare the conductive paste. Heating temperature to bake the conductive paste is arranged to be set lower than the above-described temperature, but a temperature of 200-250° C. is still desired.

As another method of forming a circuit pattern, disclosed is a liquid droplet jetting method to jet a liquid material in the form of liquid droplets from a liquid droplet head, that is, a method of forming a wiring pattern on the substrate with an inkjet system (refer to Patent Document 2 and 3). In this method, wiring pattern forming ink as a functional solution in which conductive particles such as metal particles or the like are dispersed is directly pattern-printed onto a substrate with an inkjet recording system, and is subsequently converted into a conductive pattern of a thin film via a heat treatment and laser exposure. In the case of this method, there is the advantage such that no photolithography is required, and processes are largely simplified together with less consumption of raw material, but in cases where the organic metal compound is employed as a conductive compound, similarly to those described above, for example, a heat treatment at approximately 200° C. is conducted to obtain conductivity after forming a circuit pattern via an inkjet recording system, and an organic component of the organic metal compound is removed to form metal particles.

A product fitted with a transparent conductive film exhibiting low resistivity (low specific resistance value) together with high visible light transmittance, for example, a transparent conductive film is now utilized for a number of fields of transparent electrodes for flat displays such as a liquid crystal image display apparatus, an organic electroluminescence image display apparatus, a plasma display panel, and a field emission type display, a transparent electrode for a solar battery, electronic paper, a touch panel, an electromagnetic shielding material, an infrared reflective film and so forth, but for many of them, circuit formation on a resin film substrate such as a flexible film or the like is increasingly demanded. In cases where a circuit is formed on the surface of a low heat resistance substrate as such the resin film or the like, development of a method by which a circuit can be formed at lower temperature is demanded since a sintering process temperature of 200-250° C. described in each of Patent Documents described above exceeds a heat resistance limit of the substrate. A method of forming a pattern film via laser exposure is also known, but this method is not suitable for treatment for a large area, and large scale facilities for laser generation need to be arranged.

With respect to the above-described problem, disclosed is a method of manufacturing a wiring board by which a paste composition containing a material in which the surface of a nanosized metal particle having an average particle diameter of 1-100 nm is covered by an organic compound is supplied onto the substrate surface, and the organic compound on the nanosized metal particle is subsequently removed via a plasma treatment to coagulate nanosized metal particles for circuit formation (refer to Patent Document 4). According to this method, circuit formation is possible to be conducted without removing the organic compound on the nanosized metal particle via calcination at high temperature as described before during circuit formation employing a conductive paste, and without conducting heating at high temperature.

However, after continuous effort during intensive studies, the inventors have found out that in cases where a conductive paste composition containing an organic compound is employed for circuit pattern formation, the organic substance can not be perfectly removed, or discoloration is generated in application of the organic compound during storage of the resulting circuit pattern for a long duration at high temperature, since the portion in which the organic substance is removed becomes porous, and the resulting circuit pattern exhibits insufficient properties of conductivity, film strength, transmittance and so forth even though being able to remove the organic substance.

Patent Document 1: Japanese Patent O.P.I. Publication No. 2002-299833

Patent Document 2: U.S. Pat. No. 5,132,248

Patent Document 3: Japanese Patent O.P.I. Publication No. 2004-314056

Patent Document 4: Japanese Patent O.P.I. Publication No. 2005-135982

### DISCLOSURE OF THE INVENTION

### Problems to be Solved by the Invention

The present invention has been made on the basis of the above-described situation, and it is an object of the present invention to provide a method of forming a pattern film by which a pattern film exhibiting excellent properties of conductivity, film strength and transmittance, and also exhibiting improved stability at high temperature and high humidity can be formed with an easy-to-use apparatus, and a pattern film forming apparatus thereof.

### Means to Solve the Problems

The above-described object of the present invention was accomplished by the following structures.

(Structure 1) A method of forming a pattern film comprising the steps of forming a thin film in a form of a predetermined geometric pattern on a substrate employing a solution comprising a metal ion; and subsequently treating the thin film via an atmospheric pressure plasma treatment to prepare a pattern film.

(Structure 2) The method of forming a pattern film of Structure 1, wherein the pattern film is a conductive film.

(Structure 3) The method of forming a pattern film of Structure 1 or 2; comprising the step of repeatedly forming the thin film in the form of a predetermined geometric pattern, wherein the repeatedly formed thin film is a multilayer structure film composed of at least two layers.

(Structure 4) The method of forming a pattern film of any one of Structures 1-3, comprising the step of forming the thin film in the form of a predetermined geometric pattern by an inkjet recording system.

(Structure 5) The method of forming a pattern film of any one of Structures 1-4, wherein the atmospheric pressure plasma treatment is a treatment comprising the steps of supplying gas between facing electrodes at or near atmospheric pressure to generate a high frequency electric field between the electrodes, resulting in the excited gas; and exposing the thin film in the form of a predetermined geometric pattern to the excited gas.

(Structure 6) The method of forming a pattern film of any one of Structures 1-5, wherein the substrate is a resin film, and the atmospheric pressure plasma treatment has a thin film formation temperature of 200° C. or less.

(Structure 7) A pattern film forming apparatus comprising a device of forming a thin film in a form of a predetermined geometric pattern on a substrate employing a solution containing a metal ion; and a device of conducting an atmospheric pressure plasma treatment for the thin film to form a pattern film.

(Structure 8) The pattern film forming apparatus of Structure 7, wherein the pattern film is a conductive film.

(Structure 9) The pattern film forming apparatus of Structure 7 or 8, comprising the step of repeatedly forming the thin film in the form of a predetermined geometric pattern, wherein the repeatedly formed thin film is a multilayer structure film composed of at least two layers.

(Structure 10) The pattern film forming apparatus of any one of Structures 7-9, comprising a device of forming the thin film in the form of a predetermined geometric pattern as an inkjet recording system.

(Structure 11) The pattern film forming apparatus of any one of Structures 7-10, wherein the atmospheric pressure plasma treatment is a treatment comprising the steps of supplying gas between facing electrodes at or near atmospheric pressure to generate a high frequency electric field between the electrodes, resulting in the excited gas; and exposing the thin film in the form of a predetermined geometric pattern to the excited gas.

(Structure 12) The pattern film forming apparatus of any one of Structures 7-11, wherein the substrate is a resin film, and the atmospheric pressure plasma treatment has a thin film formation temperature of 200° C. or less.

### EFFECT OF THE INVENTION

In the present invention, provided is a method of forming a pattern film by which a pattern film exhibiting excellent properties of conductivity, film strength and transmittance, and also exhibiting improved stability at high temperature and high humidity can be formed with an easy-to-use apparatus, and a pattern film forming apparatus thereof.

### BRIEF DESCRIPTION OF THE DRAWINGS

FIG. 1(a) is an oblique perspective view showing an example of an inkjet recording apparatus equipped with an inkjet head employed for a serial head system.

FIG. 1(b) is a side view showing the inkjet head.

FIG. 2 is a schematic diagram showing an example of a sheet feeding type atmospheric pressure plasma treatment apparatus equipped with a pattern forming device.

FIG. 3(a) is a schematic diagram showing an example of a roll type atmospheric pressure plasma treatment apparatus equipped with a pattern forming device.

FIG. 3(b) is a schematic diagram showing another example of a roll type atmospheric pressure plasma treatment apparatus equipped with a pattern forming device.

FIG. 4 is a schematic diagram showing another example of the atmospheric pressure plasma treatment apparatus usable for the present invention.

### EXPLANATION OF NUMERALS

1 Inkjet recording apparatus
1A Pattern forming device
2 Inkjet head
3 Nozzle
4 Carriage
5 Guiding member (Linear guide)
6 Supporting roll
7 Conveyance device
8 Liquid droplet
9 Thin film in the form of a predetermined geometric pattern
21 First electrode
22 and 32 Second electrode
22R and 35 Rotatable roll electrode
25A and 25B High frequency power supply
26A and 26B Matching box
27A and 27B Filter
30 Atmospheric pressure plasma treatment apparatus
32 Power supply
33a and 33b Electrode
34 Dielectric
35 and D Discharge space
A Liquid droplet jetting space
F, S and P Substrate

### DESCRIPTION OF THE PREFERRED EMBODIMENTS

Next, the preferred embodiments of the present invention will be explained in detail.

Studies concerning a device to form a high-quality pattern film via a simple and efficient manufacturing process have been done, so that it was found that usually, a dense pattern film in the form of a predetermined geometric pattern could not be obtained, and a flexible substrate such as a flexible film was difficult to be utilized, in cases where a predetermined geometric pattern was formed, and sintering was subsequently conducted at a high temperature of like at least 200° C. employing a conductive paste containing metal particles whose surfaces were covered by an organic compound as described in each of the foregoing Patent Documents, that is, a conductive paste containing dispersed metal particles as a solid material. On the other hand, in the case of a method of forming a pattern film employing an atmospheric pressure plasma method after forming a pattern in the form of a predetermined geometric pattern employing a conductive paste containing binder as described in the method disclosed in the foregoing Patent Document, a dense pattern film could not be formed since a certain amount of a high temperature treatment was desired as an aftertreatment in order to obtain desired performance, and unevenness and defects of a thin film were caused by scattering of binder and the like in the aftertreatment process. Particularly, in cases where the resulting pattern film was stored at high temperature and high humidity for a long duration, it was confirmed that the pattern film produced degraded resistance performance, discoloring and alteration.

After considerable effort during intensive studies, the inventors have found out that realized can be a method of forming a pattern film and a pattern film forming apparatus in which a dense conductive pattern with no defect can be formed even in a low temperature treatment, the formed pattern film having the same thickness as in the conventional method exhibits excellent properties of conductivity, film strength, transmittance and so forth together with improved stability at high temperature and humidity, and a pattern film with no lack can be stably formed with an easy-to-use apparatus by a method of forming a pattern film by which a pattern film is formed via an atmospheric plasma treatment of a thin film after providing the thin film in the form of a predetermined geometric pattern on a substrate employing a solution containing a metal ion, or by a pattern film forming apparatus equipped with a device of forming a thin film in the form of a predetermined geometric pattern on a substrate employing a solution containing an inorganic compound containing a metal ion, a device of forming a pattern film via an atmospheric plasma treatment of the thin film.

Next, a method of forming a pattern film and a pattern film forming apparatus of the present invention will be detailed in order.

### [Kinds of Pattern Films]

The pattern film formed by the method of forming a pattern film of the present invention is not specifically limited, and the intended pattern film is formed by appropriately selecting an inorganic compound containing a metal ion. An example of the pattern film formed by the method of forming a pattern film of the present invention will now be shown; but the present invention is not limited thereto.

Electrode film: Au, Al, Ag, Ti, Ti, Pt, Mo and Mo—Si

Dielectric protective film: SiO₂, SiO, Si₃N₄, Al₂O₃, Al₂O₃ and Y₂O₃

Transparent conductive film: In₂O₃ and SnO₂

Electrochromic film: WO₃, IrO₂, MoO₃ and V₂O₅

Fluorescent film: ZnS, ZnS+ZnSe, and ZnS+CdS

Magnetic recording film: Fe—Ni, Fe—Si—Al, γ—Fe₂O₃, Co, Fe₃O₄, Cr, SiO₂ and AlO₃

Superconductive film: Nb, Nb—Ge and NbN

Solar cell film: a-Si and Si

Reflection film: Ag, Al, Au and Cu

Selective absorption film: ZrC—Zr

Selective transmission films: In₂O₃ and SnO₂

Anti-reflection film: SiO₂, TiO₂ and SnO₂

Shadow mask: Cr

Wear resistance film: Cr, Ta, Pt, TiC, and TiN

Corrosion resistance film: Al, Zn, Cd, Ta, Ti and Cr

Heat resistance film: W, Ta and Ti

Lubricating film: MoS₂

Decorating film: Cr, Al, Ag, Au, TiC and Cu

### [Inorganic Compound Containing Metal Ion]

It is a feature in the method of forming a pattern film of the present invention that thin films in the form of a predetermined geometric pattern are formed employing a solution containing a metal ion. The solution containing a metal ion in the present invention is basically formed from an inorganic compound containing a metal ion and a solvent thereof, and contains no binder such as a polymer or the like.

Metal particles are replaced by conductive paste or the like as a solid dispersion for forming a thin film in the form of a predetermined geometric pattern to utilize a solution in which the inorganic compound containing a metal ion is completely dissolved with a solvent, as described above.

Examples of the inorganic compound containing a metal ion in the present invention include a metal salt, an inorganic metal compound, metal halide, a metal hydride and so forth.

Examples of metals contained in metal salts, organic metal compounds, metal halides and metal hydrides include Ag, Li, Be, B, Na, Mg, Al, Si, K, Ca, Sc, Ti, V, Cr, Mn, Fe, Co, Ni, Cu, Zn, Ga, Ge, Rb, Sr, Y, Zr, Nb, Mo, Cd, In, Ir, Sn, Sb, Cs, Ba, La, Hf, Ta, W, Tl, Pb, Bi, Ce, Pr, Nd, Pm, Eu, Gd, Tb, Dy, Ho, Er, Tm, Yb and Lu.

In the present invention, an inorganic compound containing a metal ion is preferably a metal salt or a metal halide, but more preferably a metal hydride. Examples of the metal halide include silver chloride, silver bromide, indium chloride, stannous chloride, copper chloride, nickel chloride and so forth. Examples of the metal salt include sulfate, sulfite, nitrate, nitrite, carbonate, phosphate, phosphite, silicate and so forth, and specific examples thereof include indium nitrate, silver nitrate, tin nitrate, zinc nitrate, gallium nitrate, copper nitrate and so forth.

In the present invention, the above-described pattern film forming material is dissolved in a liquid medium. The medium is not specifically limited provided that it is capable of dissolving an inorganic compound containing a metal ion of the present invention, but examples thereof include organic solvents such as methanol, ethanol, isopropanol, butanol, n-hexane and so forth, water, and a mixed solvent thereof. Water is preferable as the medium, and the medium preferably has a water content of at least 50% by weight.

### [Method of Forming Pattern Film]

In the method of forming a pattern film of the present invention, a method of forming a thin film in the form of a predetermined geometric pattern employing a solution containing an inorganic compound containing a metal ion is not specifically limited, but a printing process, a spraying process, an inkjet recording system can be utilized. Of these, a pattern in the form of a predetermined geometric pattern is preferably formed specifically via the inkjet recording system.

The geometric graphic of the present invention include means a combination pattern of a triangle such as a regular triangle, isosceles triangle, right-angled triangle or the like; a square such as a regular square, rectangle, rhombus, parallelogram, trapezoid or the like; a (regular) n-angled shape such as a (regular) hexagon, (regular) octagon, (regular) dodecagon, (regular) icosagon or the like; a circle, a ellipse, a star shape and so forth, and a single unit repeated out of these units or at least two kinds in combination can also be utilized. In cases where desired is transparent performance concerning electromagnetic wave shielding applied for a transparent electrode substrate for a flat panel display and for a PDP front plane, the pattern preferably has an aperture ratio of at least 50%, and more preferably has an aperture ratio of at least 60%. The aperture ratio means a percentage of a ratio in which the area obtained by subtracting the total area of patterned geometric graphic pattern film from the effective area of a substrate is divided by the effective area.

Such the geometric graphic preferably has a line width of 40 μm or less, a line interval of at least 100 μm, and a line thickness of 18 μm or less. Further, a line width of 25 μm or less is preferable in view of geometric graphic invisibility. A line interval of at least 120 μm and a line thickness of 18 μm or less are more preferable in view of visible light transmittance. Visible light transmittance is improved since the wider the line interval, the larger the aperture ratio is, but a line interval of 1 mm or less is preferable since conductivity and so forth are lowered. Incidentally, when the line interval is complicated in combination with geometric graphics and so forth, the area is converted into the area of a regular square, based on the repeating unit to designate a side length of the square as the line interval. In addition, the line width specifically has no lower limit and the lower limit may be set to 5 μm, but in the case of a small line interval, difficult production results.

The typical method of forming a pattern film will be described below.

### (Pattern Formation Via Printing Process)

Letterpress reversed offset is suitable for a printing process utilized for forming a thin film in the form of a predetermined geometric pattern employing a solution containing an inorganic compound containing a metal ion. Because, this exhibits excellent printability having a high-accuracy of 50 μm or less in comparison to conventional screen printing process and planographic offset printing process, or gravure offset.

In a printing process via the letterpress reversed offset, for example, a solution containing an inorganic compound containing a metal ion is coated onto the releasing surface (blanket) of a rotational cylinder in the form of a roll employing a cap coater or the like. The cap coater supplies the solution containing an inorganic compound containing a metal into the releasing surface (blanket) via utilization of capillary action. Next, after drying for a couple of minutes, a roll-shaped or planographic letterpress is pressed to transfer and remove a solution containing an inorganic compound containing undesired metal ion. Then, a solution containing an inorganic compound containing a metal ion remaining on the rotational cylinder is transferred from the roll-shaped releasing surface (blanket) into a substrate to form a thin film in the form of a desired predetermined geometric pattern. In this case, the solution containing an inorganic compound containing a metal ion is adjusted suitably for this process so as to give an appropriate viscosity.

### (Inkjet Recording System)

In the method of forming a pattern film of the present invention, an inkjet recording system is preferably utilized as a method of forming a thin film in the form of a predetermined geometric pattern employing a solution containing an inorganic compound containing a metal ion to form a pattern film in high accuracy.

Next, described is an example of a method of forming a pattern film employing an inkjet recording apparatus.

The inkjet recording apparatus capable of applying for the method of forming a pattern film of the present invention is equipped with an energy generating device to jet a solution containing an inorganic compound containing a metal ion in the present invention; an inkjet head fitted with a nozzle to jet the solution; an electrical circuit to input a driving signal for driving an inkjet head; a jetting failure recovery device (referred to also as a maintenance device) to keep stably jetting the solution containing an inorganic compound containing a metal ion; a capping device to cover the nozzle surface with a cap member so as not to become solidified via vaporization of the solution containing an inorganic compound containing a metal ion at a standby position of the inkjet head during nonuse; and so forth.

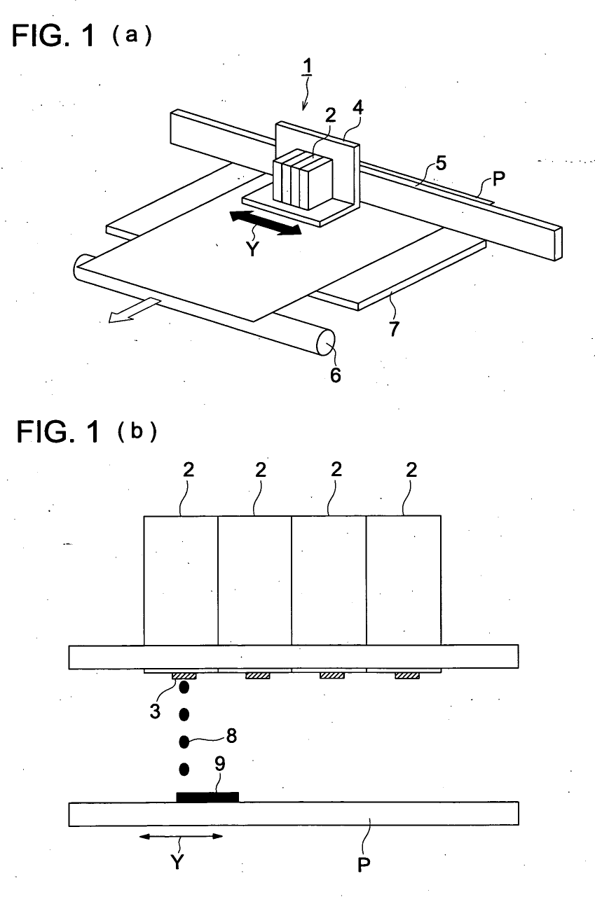

FIG. 1 is an oblique perspective view showing an example of an inkjet recording apparatus equipped with an inkjet head employed for a serial head system.

In FIG. 1(a), inkjet recording apparatus 1 is equipped with platen 7 provided horizontally with respect to substrate P, by which the back surface (the surface opposite the image formation surface side) of substrate P in the predetermined range is suctioned around the upper surface by a suction device and supported; an electrical circuit to input a driving signal for driving inkjet head 2 (not shown in the figure); inkjet head 2 fitted with a nozzle to jet a solution containing an inorganic compound containing a metal ion toward substrate P and an energy generating device to jet the solution containing an inorganic compound containing a metal ion (not shown in the figure); carriage 4 to move in the scanning direction during pattern formation while supporting inkjet head 2; a driving circuit board (not shown in the figure) in which carriage 4 is installed, to drive carriage 4 along the scanning direction during printing; guiding member (linear guide) 5 to guide movement of carriage 4 via extension along the scanning direction; linear encoder sensor output as a clock signal by reading a linear scale extended along the scanning direction in which an optical pattern is provided in the longitudinal direction, together with an optical pattern fitted to the carriage and provided in the linear scale (none of these is shown in the figure), and so forth.

In inkjet recording apparatus 1, inkjet head 2 supported by carriage 4 is provided in such a way that the pattern forming surface of substrate P conveyed on platen 7 during pattern formation and the nozzle surface on which an inkjet outlet of inkjet head 2 is formed are facing each other, and the solution containing an inorganic compound containing a metal ion in the present invention is supplied into each inkjet head 2 from a cartridge for a pattern forming solution through a tube for piping. A plurality of inkjet heads 2 are provided, if desired {4 inkjet heads 2 are shown I FIG. 1(a)}, and a solution containing an inorganic compound containing a single metal ion may be jetted employing one of these inkjet heads 2 to form a pattern film, or pattern formation may be conducted by charging the solutions each containing the inorganic compound containing each of plural metal ions formed from a different kind of metal atoms or compositions into a plurality of inkjet heads 2.

In a specific method of forming a pattern film, substrate P is guided into a guiding member (not shown in the figure), and moved in the front side direction (in the white arrow direction) from behind in FIG. 1(a) via operation of a conveyance device (not shown in the figure). An inkjet head scanning device (not shown in the figure) scans with inkjet head 2 supported with carriage 4 by reciprocating carriage 4 along guiding member (linear guide) 5 in the Y direction in FIG. 1(a).

Carriage 4 is provided on the upper side of substrate P, and inkjet heads 2 (4 heads in this case) utilized for pattern image printing on substrate P are stored by placing the jetting outlet on the lower side. Carriage 4 is installed in inkjet recording apparatus 1 in a mode freely reciprocating in the Y direction in FIG. 1(a) to reciprocate in the Y direction in FIG. 1(a) by driving a head scanning device.

Inkjet 2 jets a solution containing an inorganic compound containing a metal ion, which has been supplied by a supplying device (not shown in the figure), from a jetting outlet (nozzle portion) toward substrate P along with a predetermined geometric pattern form arranged to be set in advance via operation of a plurality of jetting devices provided inside (not shown in the figure).

As ink droplets, the solution containing an inorganic compound containing a metal ion is jetted into a given region on substrate P (pattern formation region) to land the solution in the landing-capable region during scanning such as movement of inkjet head 2 from one end of substrate P to the other end of substrate P in the Y direction in FIG. 1(a) by driving the head scanning device.

After scanning described above is conducted several times, and the solution containing an inorganic compound containing a metal ion is jetted into one landing-capable region, substrate P is appropriately moved with conveyance device 7 from behind in FIG. 1(a) toward the front side direction, and inkjet ink is jetted into the above-described landing-capable region by inkjet head 2 and into the next landing-capable region adjacent to the back area direction in FIG. 1(a) while scanning again with the head scanning device.

The above-described operation is repeated, and the solution containing an inorganic compound containing a metal ion is jetted from inkjet head 2 in conjunction with the head scanning device and conveyance device 7 to form a desired pattern image on substrate P.

FIG. 1(b) is a side view showing an inkjet recording head.

Four inkjet heads 2 supported by a carriage (not shown in the figure) are placed in a position parallel to substrate P, provided is nozzle 3 to jet the solution containing an inorganic compound containing a metal ion as liquid droplets on the opposed surface side against substrate P of each inkjet head 2.

In accordance with an intended pattern forming method, liquid droplet 8 of the solution containing an inorganic compound containing a metal ion is jetted from a nozzle portion by an electrical signal to form thin film 9 in the form of a predetermined geometric pattern on substrate P as a dot aggregate.

As the jetting method employed for an inkjet recording apparatus of the present invention, listed may be electric-machine conversion types (for example, a single cavity type, a double cavity type, a vendor type, a piston type, a share mode type, and a shared wall type etc.); electric-thermal conversion types (for example, a thermal ink jet type, a bubble jet type (registered trademark), etc.); electrostatic suction types (for example, an electric field control type, a slit jet type, etc.), an electrically discharging type (for example, a spark jet type, etc.), and so forth. Electric-machine conversion types are preferable, but any of the above types may be allowed to be used.

### [Substrate]

The substrate of the present invention is described.

The substrate of the present invention is not specifically limited, provided that a thin film in the flat form, such as a plate, sheet, or film, or a thin film in the three-dimensional form, such as a lens, is formed on the substrate. The shape and material of the substrate is not limited, provided that a uniform thin film is formed via exposure of the substrate to mixture gas plasma, wherein the substrate is either in a stationary state or in a transfer state. The shape of the substrate is either flat or three-dimensional, and the flat-shaped substrate includes a glass sheet, and a resin film. With respect to the material, various substances such as glass, a resin, pottery, metal, and a non-metallic material are utilized. Specifically, examples of the glass include a glass sheet and a lens, and those of the resin include a resin lens, a resin film, a resin sheet, and a resin plate. A resin film is specifically preferable.

The reason why a resin film is suitably utilized for a continuous and highly productive production method is that the resin film is suitable for mass production, which is not a batch one such as a vacuum system including sputtering since a pattern film can be formed on a resin film which is transferred between or near the electrodes of an atmospheric pressure plasma apparatus of the present invention.

Examples of materials for use in molded substances such as a resin film, resin sheet, resin lens and resinous molded article include cellulose ester such as cellulose triacetate, cellulose diacetate, cellulose acetate propionate or cellulose acetate butyrate; polyester such as polyethylene terephthalate or polyethylene naphthalate; polyolefin such as polyethylene or polypropylene; as well as polyvinylidene chloride, polyvinyl chloride, polyvinyl alcohol, ethylenevinyl alcohol copolymer, syndiotactic polystyrene, polycarbonate, norbornene resin, polymethylpentene, polyether ketone, polyimide, polyethersulfone, polysulfone, polyetherimide, polyamide, fluorine resin, polymethyl acrylate, acrylate copolymer and so forth.

These materials may be utilized singly or in combination. Of these, there are preferably utilized those available on the market such as ZEONEX and ZEONOA (produced by Zeon Corp.), ARTON as an amorphous cyclopolyolefin resin (produced by JSR Corp.), PURE-ACE as a polycarbonate film (produced by Teijin Ltd.), or KONICA TAC KC4UX and KC8UX (produced by Konica Minolta Opto, Inc.). Further, even a material, exhibiting a large intrinsic double refractive index, such as polycarbonate, polyarylate, polysulfone, or polyethersulfone may be utilized to produce a usable substrate, provided that conditions for solution casting film formation or melt extrusion film formation, as well as for stretching longitudinally and laterally are appropriately set.

Of these, a cellulose ester film, being optically near-isotropic, is preferably utilized for use in an optical element. Preferable examples of the cellulose ester film include a cellulose triacetate film and cellulose acetate propionate, as described above. As the cellulose triacetate film, KONICA TAC KC4UX (produced by Konica Minolta Opto, Inc.), available on the market, is useful.

It is possible to utilize those prepared by coating gelatin, polyvinyl alcohol, an acrylic resin, a polyester resin or a cellulose ester resin onto any of these resins. Further, an anti-glare layer, a clear hard coat layer, a barrier layer or an anti-stain layer may be formed on the thin film side of these resin films. Further, an adhesion layer, an alkali barrier coat layer, a gas barrier layer, or a solvent resistant layer may be formed, if desired.

Further, the substrate of the present invention is not limited to those described above. The film thickness of the film substrate is preferably in the range of 10-1000 μm, but is more preferably 40-200 μm.

### [Atmospheric Pressure Plasma Process]

It is a feature that a pattern film forming apparatus of the present invention possesses the step of forming a thin film in the form of a predetermined geometric pattern on a substrate employing a solution containing an inorganic compound containing a metal ion in accordance with the above-described process, followed by the step of conducting an atmospheric pressure plasma treatment for the thin film to form a pattern film.

According to the present invention, it is preferable that an atmospheric pressure plasma treatment is one in which gas is supplied between facing electrodes at or near atmospheric pressure to generate a high frequency electric field between the electrodes, resulting in the excited gas, and a solution containing an inorganic compound containing a metal ion in the present invention is exposed to the foregoing excited gas. Then, the foregoing solution is activated to form a pattern film as a thin film on a substrate.

For use in an electrode, gas supplied between the electrodes, and a method of generating a high frequency electric field utilized in the atmospheric pressure plasma treatment, employed can be any of those described in WO 02/48428 and Japanese Patent O.P.I. Publication No. 2004-68143.

Pressure at or near atmospheric pressure refers to one being approximately 20-110 kPa, and it is preferable that the pressure is 93-104 kPa.

As the electrode, one obtained by coating a dielectric on a metallic base material is preferable. It is preferable that the dielectric is coated on at least either the electrode or the facing ground electrode, but coating of both of the electrode and the facing ground electrode with the dielectric is more preferable. The dielectric is preferably made of an inorganic compound exhibiting a specific dielectric constant of 6-45, and examples thereof include ceramics such as alumina or silicon nitride, or glass-lining materials such as silicate glass or borate glass.

In the present invention, the gas supplied between the electrodes contains at least a discharge gas. The discharge gas is one which is discharged via voltage application. The discharge gas includes nitrogen, a rare gas, air, hydrogen, and oxygen. These gases may be utilized singly or in combination. In the present invention, nitrogen or argon is preferable as the discharge gas. In the case, a plurality of nitrogen and rare gases may be mixed as the discharge gas. It is preferable that the discharge gas is contained at a ratio of 90-99.9% by volume, based on the total volume of the gas supplied into the discharge space.

The gas supplied between the electrodes may contain an additive gas to promote reaction to form a thin film in addition to the above discharge gases. Examples of the additive gas include oxygen, ozone, hydrogen peroxide, carbon dioxide, carbon monoxide, hydrogen, and ammonia. Of these, oxygen, carbon monoxide, and hydrogen are preferable, and any gases selected from these gases may be preferably mixed as the components. Further, it is preferable that the selected gas is contained at a ratio of 0.01-5% by volume based on the total volume of the gas, whereby the reaction may be promoted, resulting in formation of a dense and high-quality thin film pattern.

The gas itself, supplied between the electrodes, is activated via voltage application to give excited gas. And then it is presumed that when a solution containing an inorganic compound containing a metal ion in the present invention is exposed to the excited gas, the solution is changed into a state where a pattern film is formed on a substrate.

The high frequency electric field generated between the electrodes may be either an intermittent pulse wave or a continuous sine wave, but the continuous sine wave is preferable to produce better effects of the present invention.

The high frequency electric field preferably has a frequency of 100-150 MHz.

Further, a power density supplied between the electrodes is preferably at least 1.0 W/cm², and the upper limit is preferably at most 50 W/cm², and more preferably at most 20 W/cm².

Incidentally, when gas supplied between the electrodes contains nitrogen as the discharge gas, it is preferable that two kinds of high frequency electric fields are superposed since a large intensity of the electric field to initiate discharge is desired. In this manner, even when employing nitrogen as the discharge gas, high-density plasma may be generated, resulting in formation of a high-quality thin film and high-speed film formation, as well as further resulting in inexpensive and safe operations, and in reduced environmental load. Application of two kinds of the high frequency electric fields makes it possible to maintain a stable discharge state via satisfaction of the following relationships.

Namely, frequency ω₂ of the second high frequency electric field is higher than frequency ωᵢ of the first one, and the relationship among intensity V₁ of the foregoing first high frequency electric field, intensity V₂ of the foregoing second one and intensity IV of the discharge initiating electric field satisfies inequality V₁≧IV>V₂ or V₁>IV≧V₂. Herein, the frequency of the first high frequency electric field is preferably at most 200 kHz. The lower limit thereof is preferably approximately 1 kHz. In contrast, the frequency of the second high frequency electric field is preferably at least 800 kHz. A higher frequency of the second high frequency electric field results in a higher plasma density, whereby dense and high-quality thin films are obtained. The upper limit thereof is preferably about 200 MHz.

A solution containing an inorganic compound containing a metal ion, provided in the form of pattern on a substrate, is exposed to the electric field generated between electrodes in such a way, and activated to conduct pattern film formation on the substrate.

### (Atmospheric Pressure Plasma Treatment Apparatus)

Now, the atmospheric pressure plasma treatment apparatus of the present invention will be described referring to figures. Herein, the embodiments of the present invention are not limited thereto.

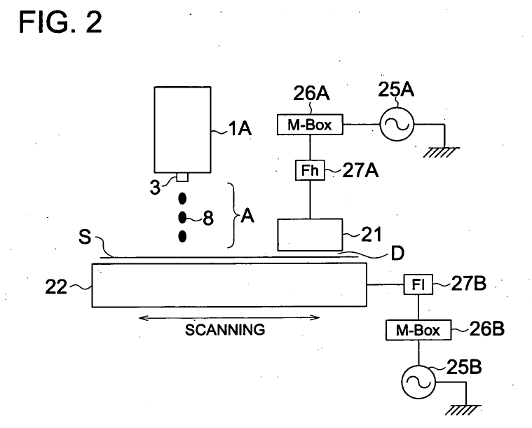

FIG. 2 is a schematic diagram showing an example of a sheet feeding type atmospheric pressure plasma treatment apparatus equipped with a pattern forming device. In FIG. 2, 1A is designated as a pattern forming device such as an inkjet recording head or the like. Liquid droplets containing an inorganic compound containing a metal ion which are jetted in the direction of a lower portion from pattern forming device 1A are to be provided in the form of pattern on, substrate S in liquid droplet jetting space A. Symbol 21 is a first electrode fixed and symbol 22 is a second electrode being capable of performing reciprocating movements in the direction of the white arrow shown in the figure while supporting substrate S. First electrode 21 and second electrode 22, facing each other, are arranged to be provided so that the predetermined gap is created between the electrodes. This gap constitutes discharge space D. First electrode 21 and second electrode 22 are connected to each of loads, which is filter 27A or 27B, matching box 26A or 26B, and high frequency power supply 25A or 25B, and are connected to ground. Filters 27 A and 27B, functioning to superpose two kinds of different high frequency electric fields in discharge space D, are inserted so as for each of the high frequency waves not to affect its corresponding power supply. Further, matching boxes 26 A and 26B are inserted to correct impedance levels by canceling reactance components possessed by the loads to effectively utilize energy generated by high frequency power supplies 25A and 25B.

The first high frequency electric field generated by high frequency power supply 25A and the second high frequency electric field generated by high frequency power supply 25B satisfy the following relationship: frequency ω₂ of the second high frequency electric field is higher than frequency ω₁ of the first high frequency electric field, and the relationship among intensity V₁ of the first high frequency electric field, intensity V₂ of the second high frequency electric field, and intensity IV of the discharge initiating electric field satisfies following equation V₁≧IV>V₂ or V₁>IV≧V₂. As described above, a stable and high-density discharge state may be achieved by superposing two kinds of the high frequency electric fields satisfying the relationship, even when employing gas such as nitrogen exhibiting a high intensity of the discharge initiating electric field, resulting in high-quality pattern film production.

For example, a high frequency of 100 kHz is employed for the first high frequency electric field, and a high frequency of 13.56 MHz is employed for the facing second high frequency electric field. A discharge space is created between the electrodes by introducing a mixed gas of 0.1% by volume of oxygen and 1% by volume of hydrogen, based on nitrogen gas.

Gas used in the discharge space is continuously or intermittently introduced outside the film-forming space by an exhaust system unshown in the figure. The exhaust system including the whole electrode space and coating space may exhaust the entire space, or locally, the electrode section and the coating section may be individually exhausted.

Substrate S placed on second electrode 22, moves in a reciprocatory manner between liquid droplet jetting space A and discharge space D. A solution containing an inorganic compound containing a metal ion is provided on substrate S in liquid droplet jetting space A. In discharge space D, a discharge gas such as argon is supplied and two kinds of the high frequency electric fields are superposed, resulting in generation of high-density plasma to which substrate S on which the liquid droplets have been provided is exposed. Thin films are formed in this way, coating and exposure steps can be repeated in this thin film forming process.

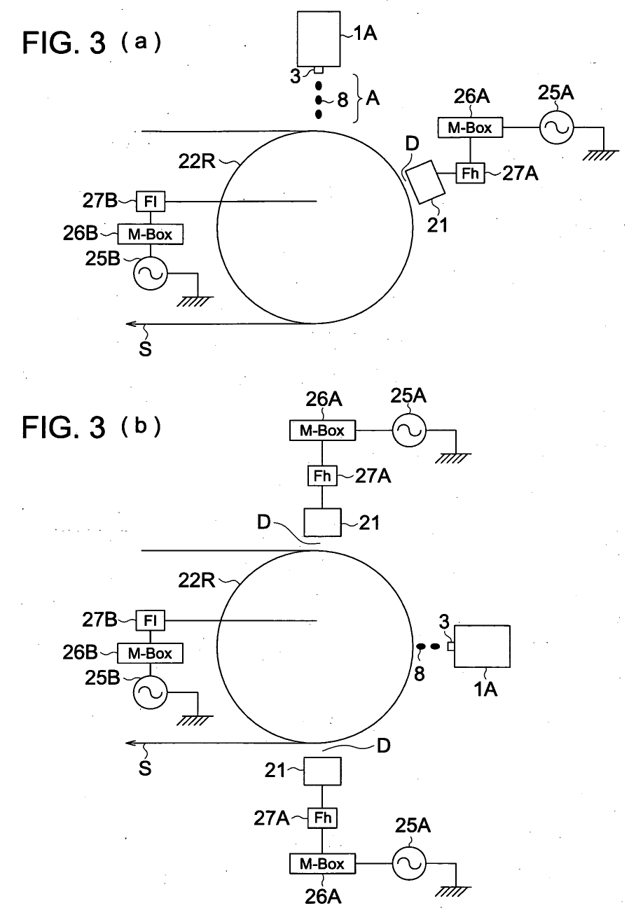

FIG. 3 is a schematic diagram showing an example of a roll type atmospheric pressure plasma treatment apparatus equipped with a pattern forming device. In FIG. 3, those, designated by the same reference symbols as in FIG. 2, are the same members as described in FIG. 2.

In FIG. 3(a), symbol S is a long-length flexible substrate such as a plastic film. Substrate S, wound around roll electrode 22R, being a second electrode, is transported in the direction of the arrow in the figure. Liquid droplets of a solution containing an inorganic compound containing a metal ion to be sprayed from a pattern forming device 1A, are provided on substrate S in liquid drop jetting space A. And thereafter a thin film in the form of pattern is formed while substrate S on which liquid droplets are provided passes through discharge space D formed between first electrode 21 and second electrode 22R. A multilayer pattern film having at least two layers can be formed by repeating this operation.

Further, a roll type atmospheric pressure plasma apparatus shown in FIG. 3(b) is a system in which a single pattern forming device 1A is placed in the middle position, and a plasma exposure section possessing first electrode 21 is provided on the both sides of the single pattern forming device. The plasma treatment can be continuously conducted by reciprocating substrate S employing such the system; for example, the continuous plasma treatment can be conducted in such a way that plasma treatment->formation of a film in the form of pattern by pattern forming device 1A->(plasma treatment)->plasma treatment->formation of a film in the form of pattern by pattern forming device 1A->(plasma treatment)->plasma treatment to effectively form a multilayer pattern having at least two layers.

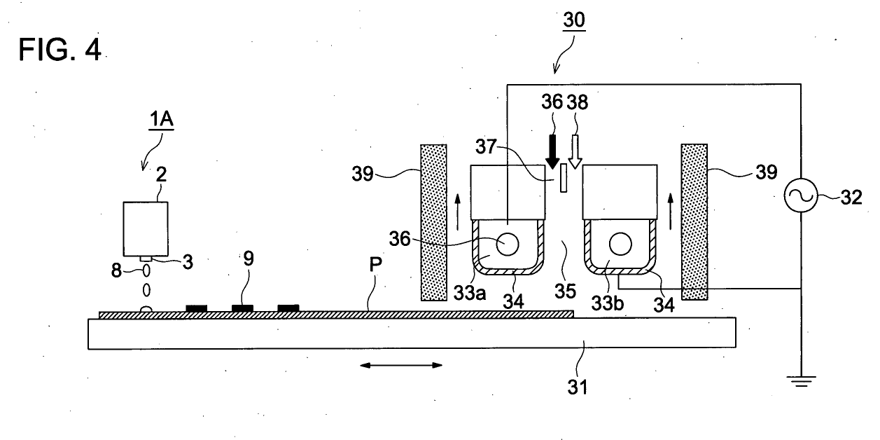

FIG. 4 is a schematic diagram showing another example of the atmospheric pressure plasma treatment apparatus usable for the present invention.

Atmospheric pressure plasma treatment apparatus 30 shown in FIG. 4 has a structure in which a discharge electrode is provided on the both sides of the substrate conveyance direction. Further, a multilayer pattern film can be formed by placing a conveyance stage capable of conveying a substrate in a reciprocatory manner.

In FIG. 4, inkjet recording head 2 as pattern forming device 1A is placed on the left hand side of the figure. A solution containing an inorganic compound is jetted as liquid droplet 8 from nozzle 3 onto substrate P supported by conveyance stage 31, and landed onto substrate P to form thin film 9 in the form of a predetermined geometric pattern.

Substrate P, on which thin film 9 in the form of a predetermined geometric pattern is formed, is moved in the right hand direction of the figure by conveyance table 31, and an activation treatment is conducted with atmospheric pressure plasma treatment apparatus 30 to form a pattern film.

In atmospheric pressure plasma treatment apparatus 30, a pair of electrodes 33a and 33b connected to power supply 32 are provided parallel to each other. At least one of electrodes 33a and 33b is covered by dielectric 34, and high frequency voltage is designed to be applied in discharge space 35 formed between the electrodes.

In addition, the inside of electrodes 33a and 33b each is composed of hollow structure 36, heat generated by discharge is removed with water, oil or such, and heat is designed to be exchanged so as to maintain temperature stably.

Gas containing a discharge gas required for discharge passes through flow path 37 from gas supply port 36, mixed via confluence with reaction-accelerating gas supplied from gas supply port 38, and supplied into space 35. High frequency waves are applied in this space 35 to generate plasma discharge, resulting in plasma formation of gas containing discharge gas. The plasma-formed gas is sprayed onto substrate P possessing thin film 9 in the form of a predetermined geometric pattern containing an inorganic metal compound, which is provided on conveyance stage 31.

The inorganic metal compound brought into contact with the plasma-formed mixed gas is chemically reacted via activation generated by plasma energy to form a pattern film on substrate P.

Conveyance stage 31 having substrate P thereon has a structure capable of reciprocatory scanning or continuous scanning, and a structure in which heat is designed to be exchanged so as to maintain the substrate temperature similarly to the case of electrodes.

Further, gas exhaust mechanism 39 to exhaust gas sprayed onto substrate P can be installed, if desired. By this, an undesired by-product produced in space can be removed smoothly from the upper portion of the discharge space or substrate P.

An example of a plate type plane substrate is shown in FIG. 4, but a solid material substrate and a film-shaped substrate are also possible to be utilized by changing a structure of a moving stage.

Further, a plurality of this atmospheric pressure plasma treatment apparatus may be placed in the scanning direction of the conveyance stage to improve performance of pattern film formation.

Further, though being unshown in FIG. 4, the inside of the apparatus can be arranged to be set under a given gas atmosphere by producing a structure in which the entire electrode and stage are enclosed, and no outside air is leaked in, whereby a desired high-quality thin film can be prepared.

During activation of a pattern film with an atmospheric pressure treatment apparatus of the present invention described before referring to figures, in order to heat or cool the rotatable roll electrode (the first electrode) and the rectangular cylinder-shaped electrodes (the second electrodes), temperature is preferably adjusted from the inside of the electrodes by transferring a medium, the temperature which has been adjusted by an electrode temperature adjusting device, to both of the electrodes via a pipe using a solution-feeding pump.

In each figure, each of the rectangular cylinder-shaped electrodes may be a cylindrical electrode, but the rectangular cylinder-shaped electrodes produce the effect of further expanding the discharge range (discharge area), compared with the cylindrical electrode, whereby the rectangular cylinder-shaped electrodes are preferably utilized in the present invention.

When a dielectric is formed on one of the electrodes, the distance between the first and second electrodes, facing each other, refers to the shortest distance between the surface of the dielectric and that of a conductive metal base material of the other electrode. When the dielectric is formed on both of the electrodes, the distance refers to the shortest distance between both surfaces of the dielectric. The distance is determined in consideration of the thickness of the dielectric formed on the conductive metal base material, the intensity of an applied electric field, and the purpose of using plasma, but in any case, the distance is preferably 0.1-20 mm, and more preferably 0.5-2 mm in view of producing of uniform discharge.

For atmospheric pressure plasma treatment vessel 31, a treatment vessel made of PYREX (trademark) glass is preferably employed, but a metal vessel may be utilized, provided that insulation is ensured between the electrodes. For example, insulation may be ensured either via adhesion of a polyimide resin to the inside of a frame made of aluminum or stainless steel or spraying of ceramics on the metal frame.

| Reference | | | | |
|---|---|---|---|---|
| number | Manufacturer | Frequency | | Product name |
| A1 | Shinko Electric Co., Ltd. | 3 | kHz | SPG3-4500 |
| A2 | Shinko Electric Co., Ltd. | 5 | kHz | SPG5-4500 |
| A3 | Kasuga Electric Works, Ltd. | 15 | kHz | AGI-023 |
| A4 | Shinko Electric Co., Ltd. | 50 | kHz | SPG50-4500 |
| A5 | Haiden Laboratory Inc. | 100 | kHz* | PHF-6k |
| A6 | Pearl Kogyo Co., Ltd. | 200 | kHz | CF-2000-200k |
| A7 | Pearl Kogyo Co., Ltd. | 400 | kHz | CF-2000-400k |

Any of the above commercially available power supplies can be employed as the first power supply (high frequency power supply) installed in an atmospheric pressure plasma treatment apparatus.

| Reference | | | | |
|---|---|---|---|---|
| number | Manufacturer | Frequency | | Product name |
| B1 | Pearl Kogyo Co., Ltd. | 800 | kHz | CF-2000-800k |
| B2 | Pearl Kogyo Co., Ltd. | 2 | MHz | CF-2000-2M |
| B3 | Pearl Kogyo Co., Ltd. | 13.56 | MHz | CF-5000-13M |
| B4 | Pearl Kogyo Co., Ltd. | 27 | MHz | CF-2000-27M |
| B5 | Pearl Kogyo Co., Ltd. | 150 | MHz | CF-2000-150M |

Further, any of the above commercially available power supplies can be employed as the second power supply (high frequency power supply).

In the above power supplies, “*” represents an impulse high frequency power supply (100 kHz in continuous mode) manufactured by Haiden Laboratory Inc., and others are high frequency power supplies capable of applying electric field of only continuous sine wave.

In the present invention, electrodes capable of maintaining a uniform and stable discharge state is preferably employed in the atmospheric pressure plasma discharge treatment apparatus by supplying such an electric field.

In the present invention, the power applied between facing electrodes supplies a power (power density) of at least 1 W/cm² to the second electrode (the second high frequency electric field), energy is given to the thin film forming liquid droplets by generating plasma via excitation of the discharge gas to form a thin film. The upper limit of power supplied to the second electrode is preferably 50 W/cm², and more preferably 20 W/cm². The lower limit of power is preferably 1.2 W/cm². The discharge area (cm²) refers to the area in the region where discharge is generated between electrodes.

Further, the power density can be enhanced while maintaining the uniformity of the second high frequency electric field, by, supplying power (power density) of at least 1 W/cm² to the first electrode (the first high frequency electric field), whereby more uniform plasma having higher density can be produced, resulting in an improved film forming rate and film quality at the same tome. The power supplied to the first electrode is preferably at least 5 W/cm². The upper limit of power supplied to the first electrode is preferably 50 W/cm².

Herein, the waveform of the high frequency electric field is not specifically limited. There are a continuous oscillation mode which is called a continuous mode with a continuous sine wave and a discontinuous oscillation mode which is called a pulse mode carrying out ON/OFF discontinuously, and either may be used, but a method supplying a continuous sine wave at least to the second electrode side (the second high frequency electric field) is preferred to obtain a uniform film with high quality.

In the present invention, the atmospheric pressure plasma treatment preferably has a thin film formation temperature of 200° C. or less in order to largely produce effects of the purpose in the present invention.

### EXAMPLE

Next, the present invention will be detailed referring to examples, but the present invention is not limited thereto. Incidentally, “parts” and “%” shown in the examples are used in the present invention, but “parts” and “%” refer to “parts by weight” and “% by weight”, respectively, unless otherwise specified.

### <<Formation of Pattern Film>>

### Comparative Example 1

The following clear hard coat layer (UV curable resin layer) coating solution was filtrated by a polypropylene filter having a pore diameter of 0.4 μm to prepare a hard coat layer coating solution, the resulting was coated onto a polyethylene terephthalate (PET) film (A-4100, produced by Toyobo Co., Ltd.) having a thickness of 100 μm as a plastic film employing a microgravure coater, and subsequently dried at 90° C. Then, the coated layer was cured via UV exposure of 150 mJ/cm², and the clear hard coat layer having a thickness of 5 μm to prepare a substrate.

### <Clear Hard Coat Layer Coating Solution>

| | |
|---|---|
| Dipentaerythritol hexaacrylate (containing | 100 parts by weight |
| components of dimer and trimer or more) | |
| Photoreactive initiator | 4 parts by weight |
| Acetic ether | 50 parts by weight |
| Methylethyl ketone | 50 parts by weight |
| Isopropyl alcohol | 50 parts by weight |

Next, a lattice pattern of silver paste (EpimerEM-4500, produced by Hitach Chemical Co., Ltd.) was formed on the clear hard coat layer of the above-described substrate by a letterpress reversed offset printing method. Then, conductive paste is heated at 120° C. for 2 hours, and cured, to prepare patterning formation film 1. The geometric graphic of this patterning formation film 1 had an aperture ratio of 81%. Incidentally, the aperture ratio of the geometric graphic pattern was measured based on a differential interference type microscopy image.

### Comparative Example 2

A lattice patter was formed similarly to preparation of patterning formation film 1 in the above-described Comparative example 1, except that conductive paste was replaced by silver paste (EpimerEM-4500), and silver paste 2 in which silver particles were contained in a photosensitive resin composition composed of the following composition was employed. Next, a pattern formed from silver paste 2 was exposed to UV rays of 1 J/cm² employing a UV lamp for curing, and heated further at 120° C. for 60 minutes to prepare patterning formation film 2.

### <Preparation of Silver Paste 2>

| | |
|---|---|
| 2,2-bis (4,4-N-maleimidyl phenoxyphenyl) | 30 parts by weight |
| Propane | |
| Acid-modified epoxy resin obtained by | 45 parts by weight |
| reacting one equivalent tetrahydro acid | |
| phthalic anhydride with bisphenol A type | |
| epoxy resin of epoxy equivalent 500 | |
| under nitrogen atmosphere at 150° C. | |
| for 10 hours | |
| Acrylonitrile butadiene rubber (PNR-1H, | 20 parts by weight |
| produced by JSR corporation) | |
| 1,3-bis[9,9-diacridino] heptane | 5 parts by weight |
| Aluminum hydroxide | 10 parts by weight |

Silver particles are dispersed in varnish containing 45% by weight of the above-described each composition and cyclohexane/methylethyl ketone (weight ratio of 1/1) so as to give 30% by volume to prepare silver paste 2.

### Comparative Example 3

Patterning formation film 3 was prepared similarly to preparation of patterning formation film 1 in the above-described comparative example 1, except that an oxygen plasma treatment was conducted in accordance with the following method.

Exposure was conducted for an oxygen plasma treatment at an electric power of 200 W under the condition of an oxygen flow of 50 sccm for 5 minutes. This plasma treatment was conducted at a temperature of 110° C., and the resulting patterning formation film 3 had a specific resistance of 2×10⁻³ Ω·cm.

### Comparative Example 4

### Preparation of Solution Containing Inorganic Compound Containing Metal Ion

Silver chloride was dissolved employing a mixed solution of water and ethylene glycol so as to give 0.05 mol % to prepare a silver solution. In this case, a ratio of the solution was set to 50% by volume of water and 50% by volume of ethylene glycol.

### <Formation of Lattice Pattern>

The same lattice pattern {a line width of 25 μm and an line interval (pitch) of 250 μm} as in Comparative example 1 was formed employing an on-demand type inkjet printer having the maximum recording density of 720×720 dpi, in which the above-described prepared silver solution was charged into a piezo type inkjet recording head of 128 nozzles having a nozzle diameter of 25 μm at a drive frequency of 12 kHz, and a nozzle density of 180 dpi (“dpi” indicates the number of dots per 2.54 cm in the following description).

After heating at 150° C. for 3 hours, cooling was conducted at room temperature spending one hour to prepare patterning formation film 4.

In addition, in the case of the resulting patterning formation film 4, the pattern film was not cured even after heating, and when a cellophane tape was lifted in the upper direction after attaching the cellophane tape onto the pattern film surface, the pattern film was easily peeled off.

### Example 1

After pattern-forming a lattice pattern {a line width of 25 μm and an line interval (pitch) of 250 μm} by the same method as in Comparative example 4 employing an atmospheric pressure treatment apparatus shown in FIG. 4, a plasma treatment was conducted for 10 seconds to prepare patterning formation film 5 having a lattice pattern composed of a single layer.

In an atmospheric pressure plasma treatment apparatus, a high frequency power supply having a frequency of 100 kHz is connected to an electrode supporting a substrate, and a high frequency power supply having a frequency of 13.56 MHz is connected to a facing rod-shaped electrode thereof and also a matching box, functioning to match impedance, is connected between the power supply main body and the electrode. Further, a filter is placed between the matching box and the electrode in such a way that no mutual current flows in to each other. Discharge was formed by introducing a mixed gas of 3% by volume of hydrogen gas based on nitrogen gas into discharge space. Since the portion exposed to plasma gas is located in the downstream of inkjet jetting space, the substrate is to be exposed to plasma gas immediately after pattern formation.

Incidentally, the power density of the high frequency power supply having a frequency of 100 kHz was set to 3 W/cm², and the power density of the high frequency power supply having a frequency of 13.56 MHz was set to 5 W/cm². Further, an electrode supporting a substrate in activation of a pattern film is capable of recreating an XY position coordinate precisely, and maintained at 80° C. for heat-retention by circulating a medium for heat-retention into the interior.

### Example 2

Patterning formation film 6 having the lattice pattern composed of 4 layered pattern films was prepared similarly to preparation of patterning formation film 5 described in the above-described Example 1, except that a step of forming the lattice pattern by an inkjet recording system, followed by an activation treatment step employing an atmospheric pressure plasma apparatus was continuously repeated 4 times.

### Example 3

### Formation of Lattice Pattern

Indium chloride (InCl₃.3.5H₂O, purity: 99.99%, produced by Kojundo Chemical Laboratory Co., Ltd.) and stannous chloride (SnCl₂.2H₂O, purity: 99.9%, produced by Kojundo Chemical Laboratory Co., Ltd.) as an inorganic tin compound were dissolved in 100 ml of butanol and stirred for one hour, in such a manner that the total metal component is allowed to be approximately 0.05 mol/liter, the tin concentration in the metal component is allowed to be 10 at %, and the indium concentration in the metal component is allowed to be 90 at %, to prepare a solution containing tin atoms and indium stoms.

Next, in the same method as in Example 4 employing this solution, after pattern-forming lattice pattern lattice {a line width of 25 μm and an line interval (pitch) of 250 μm} by an inkjet recording system, the resulting lattice pattern film was subjected to a plasma treatment for 10 seconds with an atmospheric pressure plasma treatment apparatus. A step of forming the lattice pattern by an inkjet recording system as described above, followed by an activation treatment step employing an atmospheric pressure plasma apparatus was continuously repeated 4 times to prepare patterning formation film 7 having the ITO lattice pattern composed of 4 layered pattern films.

### Example 4

Patterning formation film 8 having the ITO lattice pattern composed of 10 layered pattern films was prepared similarly to preparation of patterning formation film 7 described in the above-described Example 3, except that a step of forming the lattice pattern by an inkjet recording system, followed by an activation treatment step employing an atmospheric pressure plasma apparatus was continuously repeated 10 times.

### <<Evaluation of Patterning Formation Film>>

As to each patterning formation film prepared as described above, presence or absence of patterning abnormality, conductivity, transmittance, adherence to a substrate and durability after storage at high temperature (discoloration and alteration of a pattern film) were evaluated in accordance with the following method. In addition, Comparative example 4 was removed from the evaluation since no lattice pattern was cured, resulting in quality unbearable to the evaluation.

### [Confirmation of Presence or Absence of Patterning Abnormality]

The lattice pattern formed on each pattering formation film was observed with a differential interference microscope to evaluate pattern presence or absence of disconnected pattern and change in lattice width.

### [Evaluation of Conductivity]

Surface specific resistance (Ω·cm) was measured by a four-terminal method in accordance with JIS R 1637. Herein, measurement was performed employing Loresta-GP MCP-T600 (produced by Mitsubishi Chemical Corp.).

### (Measurement of Transmittance)

As to transmittance of each patterning formation film, transmittance (%) at a wavelength of 550 nm was measured employing a spectrophotometer 1U-4000 type (produced by Hitachi, Ltd.) in accordance with JIS R 1635.

### [Evaluation of Adhesion]

Adhesion to a substrate of lattice pattern formed on each patterning formation film was evaluated via a cross-cut test based on JIS K 5400.

Cross-cuts of 11 lines of an interval of 1 mm perpendicular to the film surface were formed on the resulting pattern film surface in the transverse and longitudinal directions with a single-edged razor to form one hundred 1 mm square grids. Then, a commercially available cellophane tape was allowed to adhere onto the cross-cut surface, and the tape was perpendicularly peeled off one end by hand. The ratio (%) of the unpeeled pattern film area with respect to the total area of the pattern film on which a commercially available cellophane tape was attached from the cross-cut lines was measured, and this was designated as a measure of adhesion.

### [Evaluation of Durability (Heat Resistance)]

After storing each patterning formation film in a constant-temperature bath at 80° C. for 500 hours, change in appearance configuration of a pattern film (discoloration and alteration of the pattern film) was visually observed to evaluate durability in accordance with the following criteria.

A: No deformation and alteration of a pattern film is observed at all.

B: Deformation and alteration of a pattern film is hardly observed.

C: Slight deformation of a pattern film is observed, but no discoloration of the pattern film is observed.

D: Discoloration of a pattern film to brownish-red is observed.

E: Discoloration of a pattern film to brownish-red and peeling of the pattern film are observed.

TABLE 1

| | Presence or | | | | |
|---|---|---|---|---|---|
| | absence of | Conduc- | Trans- | | |
| | pattern | tivity | mittance | | Dura- |
| No. | abnormality | (Ω · cm) | (%) | Adhesion | bility |
| Comparative | absence | >1 | 80 | 32 | D |
| Example 1 | | | | | |
| Comparative | absence | >1 | 80 | 90 | D |
| Example 2 | | | | | |
| Comparative | absence | 2 × 10⁻³ | 82 | 90 | D |
| Example 3 | | | | | |
| Comparative | presence | — | — | 0 | — |
| Example 4 | | | | | |
| Present | absence | 8 × 10⁻³ | 87 | 95 | B |
| Invention 1 | | | | | |
| Present | absence | 2 × 10⁻⁵ | 85 | 100 | A |
| Invention 2 | | | | | |
| Present | absence | 8 × 10⁻⁴ | 90 | 100 | A |
| Invention 3 | | | | | |
| Present | absence | 4 × 10⁻⁴ | 90 | 100 | A |
| Invention 4 | | | | | |

As is clear from Table 1, it is to be understood that a patterning formation film having a pattern film formed in accordance with a method specified by the present invention is capable of forming a dense pattern film exhibiting excellent conductivity and high transmittance together with excellent adhesion to a substrate, and specifically, the formed pattern film exhibits excellent durability even after storage at high temperature for a long duration.

1. A method of forming a pattern film comprising the steps of:
forming a thin film in a form of a predetermined geometric pattern on a substrate employing a solution comprising a metal ion; and
subsequently treating the thin film via an atmospheric pressure plasma treatment to prepare a pattern film.

2. The method of forming a pattern film of claim 1,
wherein the pattern film is a conductive film.

3. The method of forming a pattern film of claim 1, comprising the step of:
repeatedly forming the thin film in the form of a predetermined geometric pattern,
wherein the repeatedly formed thin film is a multilayer structure film composed of at least two layers.

4. The method of forming a pattern film of claim 1, comprising the step of:
forming the thin film in the form of a predetermined geometric pattern by an inkjet recording system.

5. The method of forming a pattern film of claim 1,
wherein the atmospheric pressure plasma treatment is a treatment comprising the steps of:
supplying gas between facing electrodes at or near atmospheric pressure to generate a high frequency electric field between the electrodes, resulting in the excited gas; and
exposing the thin film in the form of a predetermined geometric pattern to the excited gas.

6. The method of forming a pattern film of claim 1,
wherein the substrate is a resin film, and the atmospheric pressure plasma treatment has a thin film formation temperature of 200° C. or less.

7. A pattern film forming apparatus comprising
a device of forming a thin film in a form of a predetermined geometric pattern on a substrate employing a solution containing a metal ion; and
a device of conducting an atmospheric pressure plasma treatment for the thin film to form a pattern film.

8. The pattern film forming apparatus of claim 7,
wherein the pattern film is a conductive film.

9. The pattern film forming apparatus of claim 7, comprising the step of:
repeatedly forming the thin film in the form of a predetermined geometric pattern,
wherein the repeatedly formed thin film is a multilayer structure film composed of at least two layers.

10. The pattern film forming apparatus of claim 7, comprising a device of forming the thin film in the form of a predetermined geometric pattern as an inkjet recording system.

11. The pattern film forming apparatus of claim 7,
wherein the atmospheric pressure plasma treatment is a treatment comprising the steps of:
supplying gas between facing electrodes at or near atmospheric pressure to generate a high frequency electric field between the electrodes, resulting in the excited gas; and
exposing the thin film in the form of a predetermined geometric pattern to the excited gas.

12. The pattern film forming apparatus of claim 7,
wherein the substrate is a resin film, and the atmospheric pressure plasma treatment has a thin film formation temperature of 200° C. or less.
